(19) United States
(12) Patent Application Publication
(10) Pub. No.: US 2017/0337270 A1
(43) Pub. Date: Nov. 23, 2017

(54) SYSTEMS AND METHODS FOR PROVIDING ONLINE FEEDBACK TO ARTISTS AND COMPETITION BETWEEN ARTISTS VIA A WEB-BASED SYSTEM AND METHODS OF USING THE SAME

(71) Applicant: JIVIN, LLC, Sleepy Hollow, NY (US)

(72) Inventor: Daniel Koch, Sleepy Hollow, NY (US)

(21) Appl. No.: 15/597,684

(22) Filed: May 17, 2017

Related U.S. Application Data
(60) Provisional application No. 62/337,451, filed on May 17, 2016.

(51) Int. Cl. G06F 17/30; H04L 12/58; G06Q 50/00; H04L 29/08

(52) U.S. Cl. CPC G06F 17/30775; H04L 67/02; H04L 51/046; G06F 17/30766; G06Q 50/01; H04L 29/08117

(57) ABSTRACT

A web-based system for providing (i) online feedback to artists and performers and (ii) online competition between artists is disclosed. Methods of using the web-based system for providing (i) online feedback to artists and performers and (ii) online competition between artists are also disclosed.

### CROSS-REFERENCE TO RELATED APPLICATIONS

This patent application claims the benefit of priority to U.S. provisional patent application Ser. No. 62/337,451 entitled “SYSTEMS AND METHODS FOR PROVIDING ONLINE FEEDBACK TO ARTISTS AND COMPETITION BETWEEN ARTISTS VIA A WEB-BASED SYSTEM AND METHODS OF USING THE SAME” filed on May 17, 2016, the subject matter of which is incorporated herein in its entirety.

### TECHNICAL FIELD

The present invention relates to a web-based system for providing online feedback to artists and performers. The present invention further relates to methods of using the web-based system for providing online feedback/rankings to artists and performers. The present invention further relates to methods of using web-based systems for providing online competitions and live stats for artists, performers and other talents.

### BACKGROUND

There is a need in the art for a web-based system for providing online feedback to artists and performers. There is a need in the art for a web-based system for providing online competitions and live stats for artists, performers and other talents.

### SUMMARY

The present invention addresses the problems in the art by providing a web-based system for providing online live feedback to artists and performers through competitions

The present invention is directed to methods of providing online feedback to artists and performers. In one exemplary embodiment, the method of providing online feedback to artists and performers comprises a method of providing on-line feedback to artists via a web-based system, the method comprising: providing a website that allows an artist to upload one or more files, wherein each uploaded file comprises visual content, audio content, or both visual and audio content; allowing access to the website so that a viewer (e.g., a paying artist/member and/or a non-paying viewer/member) can vote for one or more of the uploaded files (i.e., a voter get a single vote for each uploaded file); calculating a total number of file votes for each uploaded file within a first time period; calculating a total number of artist votes for each artist within a second time period, the total number of artist votes corresponding to a sum of file votes for all uploaded files by the artist; and in response to one or more requests by an artist or a viewer, displaying for view on the website (1) a ranking of the top X uploaded files based on the total number of file votes received for each uploaded file within the first time period, and (2) a ranking of the top Y artists based on the total number of artist votes received for each artist within the second time period.

The present invention further relates to methods of using web-based systems for providing online competitions and live stats for artists, performers and other talents. In one exemplary embodiment, the method of using web-based systems for providing online competitions and live stats for artists, performers and other talents comprises a method of providing on-line competitions and live stats for artists, performers and other talents via a web-based system, the method comprising: providing a website that allows an artist to upload and/or record one or more files, wherein each uploaded or recorded file comprises visual content, audio content, or both visual and audio content; allowing access to the website so that a viewer (e.g., a paying artist/member and/or a non-paying viewer/member) can vote for one or more of the uploaded or recorded files (i.e., a voter get a single vote for each uploaded file); calculating a total number of file votes for each uploaded or recorded file within a first time period; calculating a total number of artist votes for each artist within a second time period, the total number of artist votes corresponding to a sum of file votes for all uploaded or recorded files by the artist; and in response to one or more requests by an artist or a viewer, displaying for view on the website at least one of: (1) a ranking of the top X uploaded or recorded files based on the total number of file votes received for each uploaded or recorded file within the first time period, and (2) a ranking of the top Y artists based on the total number of artist votes received for each artist within the second time period.

The present invention is further directed to computer applications comprising the disclosed online feedback and competition systems. In one exemplary embodiment, a computer application comprises a computer application capable of being loaded onto a web-based computer system, wherein the computer application comprises software code that enables performance of any of the herein-disclosed methods. In some embodiments, the computer application may be a downloadable computer application available via the Internet (e.g., onto a computer or mobile device such as a smartphone). In other embodiments, the computer application is loaded onto a computer application media (e.g., disc, flash drive, etc.) that can be inserted into a port on a computer.

The present invention is even further directed to computer systems configured to perform any of the herein-disclosed methods. In one exemplary embodiment, the computer system comprises: a network interface; and a processor in communication with the network interface, the processor being configured to perform any of the herein-disclosed methods. The network interface may comprise one or more computing devices, such as one or more laptops, one or more desktop computers, one or more smart phones, or any combination thereof.

These and other features and advantages of the present invention will become apparent after a review of the following detailed description of the disclosed embodiments and the appended claims.

### BRIEF DESCRIPTION OF THE DRAWINGS

The present invention is further described with reference to the appended figures, wherein:

FIG. 1 depicts an exemplary website log-in page for accessing the web-based computer application of the present invention;

FIG. 2 depicts an exemplary website user welcome page of the web-based computer application of the present invention;

FIG. 3 depicts an exemplary user interest page of the web-based computer application of the present invention;

FIG. 4 depicts an exemplary list of suggested artists page of the web-based computer application of the present invention;

FIG. 5 depicts an exemplary user information map page of the web-based computer application of the present invention;

FIG. 6 depicts an exemplary first user profile customization page of the web-based computer application of the present invention;

FIG. 7 depicts an exemplary second user profile customization page of the web-based computer application of the present invention;

FIG. 8 depicts an exemplary user profile notification page of the web-based computer application of the present invention;

FIG. 9 depicts an exemplary user home page set-up in progress notification page of the web-based computer application of the present invention;

FIG. 10 depicts an exemplary user home page of the web-based computer application of the present invention;

FIG. 11 depicts an exemplary view of a portion of an exemplary user home page for uploading/recording a file using the web-based computer application of the present invention;

FIG. 12 depicts an exemplary view of a portion of an exemplary user home page displaying an exemplary wall of fame of the web-based computer application of the present invention, the exemplary wall of fame showing three winners of a particular country, region, division and/or state;

FIG. 13 depicts an exemplary view of a portion of an exemplary user home page displaying an exemplary leaderboard of the web-based computer application of the present invention, the exemplary leaderboard showing four region (e.g., the west, midwest, south, and northeast regions shown in adjacent columns) leaders of the United States;

FIG. 14 depicts an exemplary view of a portion of an exemplary user home page displaying exemplary live stats of the web-based computer application of the present invention;

FIG. 15 depicts an exemplary view of a portion of an exemplary user home page displaying exemplary events of the web-based computer application of the present invention;

FIG. 16 depicts an exemplary view of a portion of an exemplary user home page displaying an exemplary detailed event page portion of the web-based computer application of the present invention, which can be linked up to GOOGLE maps to provide directions to an event location;

FIG. 17 depicts an exemplary drop down option/menu of a user's home page of the web-based computer application of the present invention;

FIG. 18 depicts an exemplary system for performing the computer applications of the present invention; and

FIG. 19 depicts an exemplary view of an exemplary leaderboard of the web-based computer application of the present invention, the exemplary leaderboard showing four regions (e.g., the west, midwest, south, and northeast regions shown in adjacent columns), and the top ten leaders within the four regions of the United States.

### DETAILED DESCRIPTION OF THE INVENTION

The present invention is directed to online feedback and competition systems, computer applications comprising online feedback and competition systems, and methods of using computer applications to (1) market one's talents, (2) obtain online feedback with regard to an artists' work, and (3) enable online competition between artists. The feedback consists of how other members (e.g., paying and non-paying members) of JIVIN (i.e., the name of the website www.jivin.com and the application supporting the herein-disclosed methods and systems) feel about the artists' files that are uploaded. The term “feel” relates to how many votes the artist has for a particular file or cumulated uploaded or recorded files and where that ranks that artist within the area the artist lives in.

The online feedback and competition systems, computer applications comprising online feedback and competition systems, and methods of using computer applications of the present invention may comprise a number of components. A description of individual features and method steps is provided in the embodiments below.

### EMBODIMENTS

### Method Embodiments

1. A method of providing on-line feedback to artists via a web-based system 100, said method comprising: providing a website (e.g., www.jivin.com) that allows an artist to upload one or more files 50 (e.g., an audio file, a video file, etc.), wherein each uploaded file 50 comprises visual content, audio content, or both visual and audio content; allowing access to the website so that a user can vote for one or more of the uploaded files 50; and in response to one or more requests by the artist or the user, displaying for view, on one or more webpages of the website, (1) a file ranking 51 of the top X uploaded files 50 based on a total number of file votes received for each uploaded file 50 within a first time period (e.g., a given month of the year, or a given three- or four-month period, or any other period of time), and (2) an artist ranking 52 of the top Y artists 53 based on a total number of artist votes received for each artist 53 within a second time period (e.g., a given calendar quarter of the year, or a given three- or four-month period, or any other period of time), the total number of artist votes corresponding to a sum of file votes for all uploaded files 50 by a given artist 53.

2. The method of embodiment 1, wherein the uploaded file 50 comprises audio content.

3. The method of embodiment 1 or 2, wherein the uploaded file 50 comprises visual content.

4. The method of any one of embodiments 1 to 3, wherein the uploaded file 50 comprises a music video, a dance video, a comedy video, an instrument video, or a combination thereof. It should be understood that the uploaded file 50 can be any version of any talent performed by a given artist 53.

5. The method of any one of embodiments 1 to 4, wherein X is an integer ranging from 1 to 500 (or any integer between 1 and 500, e.g., 3, or any range of integers between 1 and 50, e.g., from 3 to 10), and Y is an integer ranging from 1 to 500 (or any integer between 1 and 500, e.g., 3, or any range of integers between 1 and 50, e.g., from 3 to 10).

6. The method of any one of embodiments 1 to 5, wherein X is an integer ranging from 3 to 10, and Y is an integer ranging from 3 to 250.

7. The method of any one of embodiments 1 to 6, wherein the first time period ranges from one week to one year (or any time period between one week and one year, e.g., one month, or a given three- or four-month period, or any other period of time).

8. The method of any one of embodiments 1 to 7, wherein the second time period ranges from one week to one year (or any time period between one week and one year, e.g., one calendar quarter of the year, or a given three- or four-month period, or any other period of time).

9. The method of any one of embodiments 1 to 8, wherein the second time period is longer in time than the first time period.

10. The method of any one of embodiments 1 to 9, wherein the first time period is one month, and the second time period is three months.

11. The method of any one of embodiments 1 to 10, further comprising: offering a paid subscription to the website; and in response to the artist 53 paying for the paid subscription, allowing the artist 53 to upload an unlimited number of uploaded files 50 (and/or recording an unlimited number of uploaded files 50).

12. The method of embodiment 11, wherein, prior to paying for the paid subscription, the artist 53 is limited to uploading one or more uploaded files 50 with a total number of uploaded file minutes of up to Z minutes. For example, without a paid subscription, the artist 53 may be limited to (1) uploading one uploaded file 50 with a total file minutes of 3 minutes, or (2) uploading up to three separate uploaded files 50 with a total combined file minutes of 3 minutes for the three separate uploaded files 50. In some embodiments, each uploaded file 50 for unpaid member is a maximum of 1 minute, and the total number of possible uploaded files 50 is three files. Further, in some embodiments, paid members can upload as many files as they want and each uploaded file 50 can be a maximum of three minutes in length.

13. The method of embodiment 12, wherein, prior to paying for the paid subscription, the artist 53 is limited to uploading one or more uploaded files 50 with a total number of uploaded file minutes of up to 3.0 minutes.

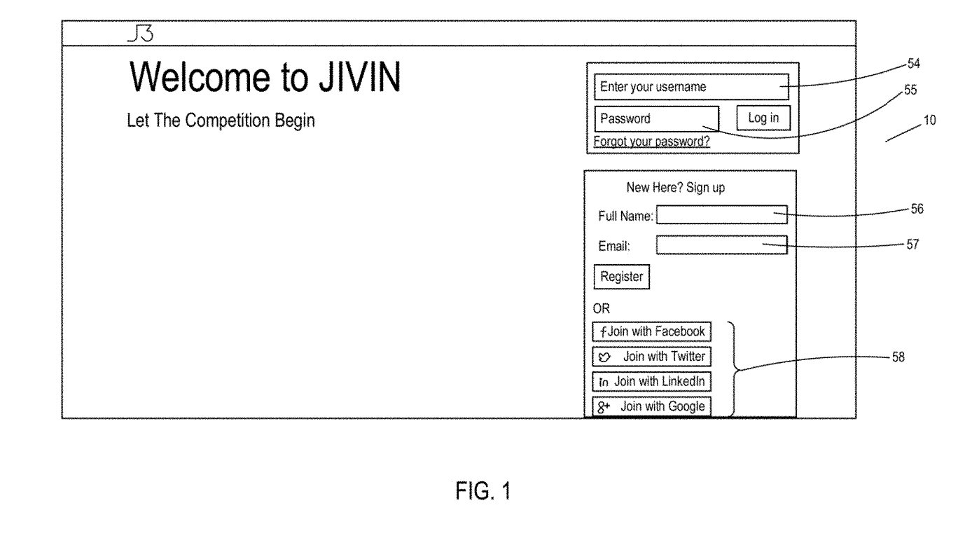

14. The method of any one of embodiments 1 to 10, further comprising: providing a website log-in page 10 so as to enable input of a user log-in name and user password; and in response to the user log-in name and the user password inputted by the user, displaying for the user a user home page 20 that provides access to multiple functions of the website. See, for example, exemplary website log-in page 10 shown in FIG. 1, which provides a user log-in name entry location 54, and a user password entry location 55 on exemplary website log-in page 10. It should be noted that exemplary website log-in page 10 also provides the following additional features: for new users of the jivin.com website, (i) a name entry location 56, an email address entry location 57, and other links 58 (e.g., FACEBOOK, LINKEDIN, etc.) that a user may use to join/register with the jivin.com website.

15. The method of embodiment 14, wherein the user log-in name comprises a user's email address.

16. The method of embodiment 14 or 15, wherein the website log-in page 11 provides other user log-in options 58, the other user log-in options comprising a user log-in via FACEBOOK, a user log-in via TWITTER, a user log-in via LinkedIn, a user log-in via GOOGLE Plus, or any combination thereof

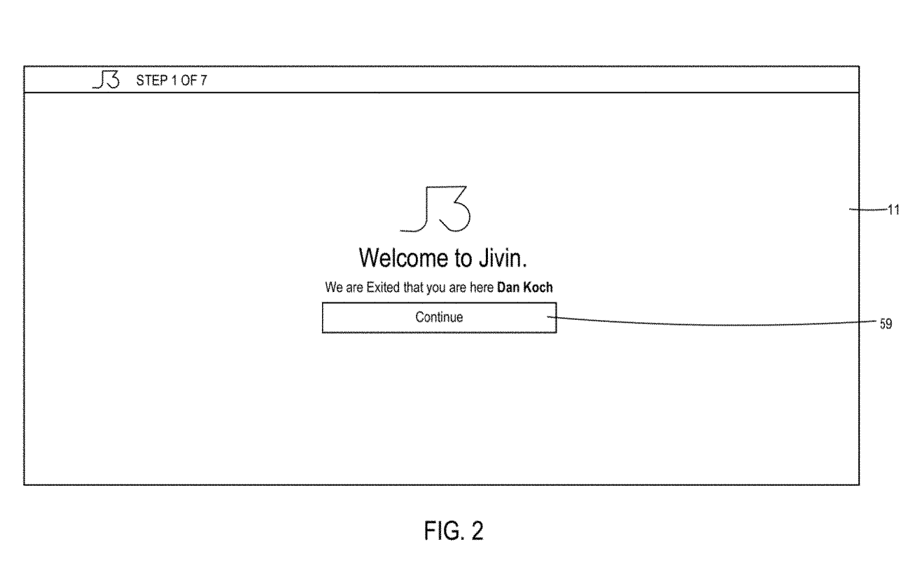

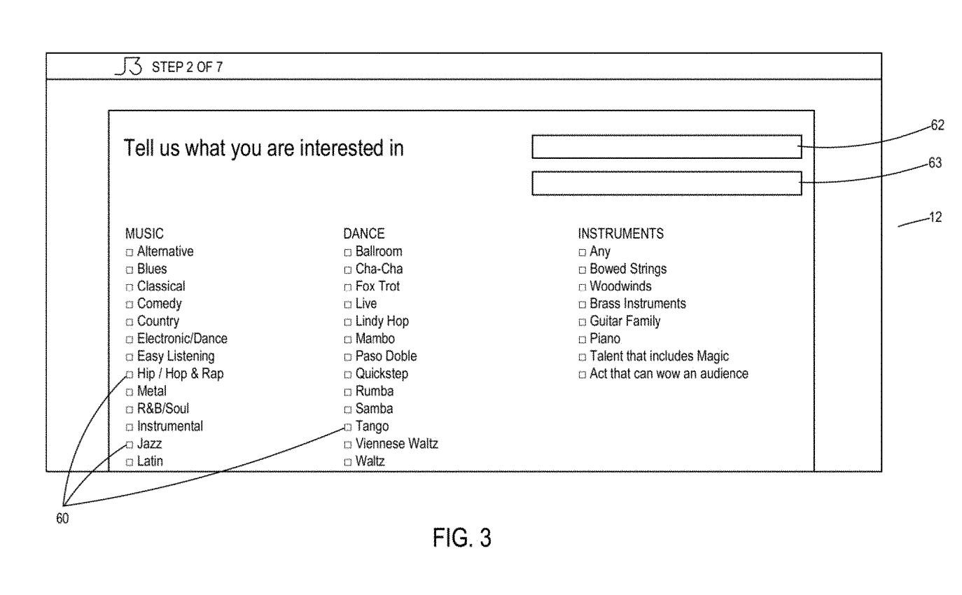

17. The method of any one of embodiments 14 to 16, further comprising: prior to displaying the user home page 20, for new users, providing a user welcome page 12 that welcomes the user to the website. See, for example, exemplary website user welcome page 11 shown in FIG. 2. By clicking on the continue button 59, a new user proceeds from exemplary website user welcome page 11 shown in FIG. 2 to a user interest page such as exemplary user interest page 12 shown in FIG. 3.

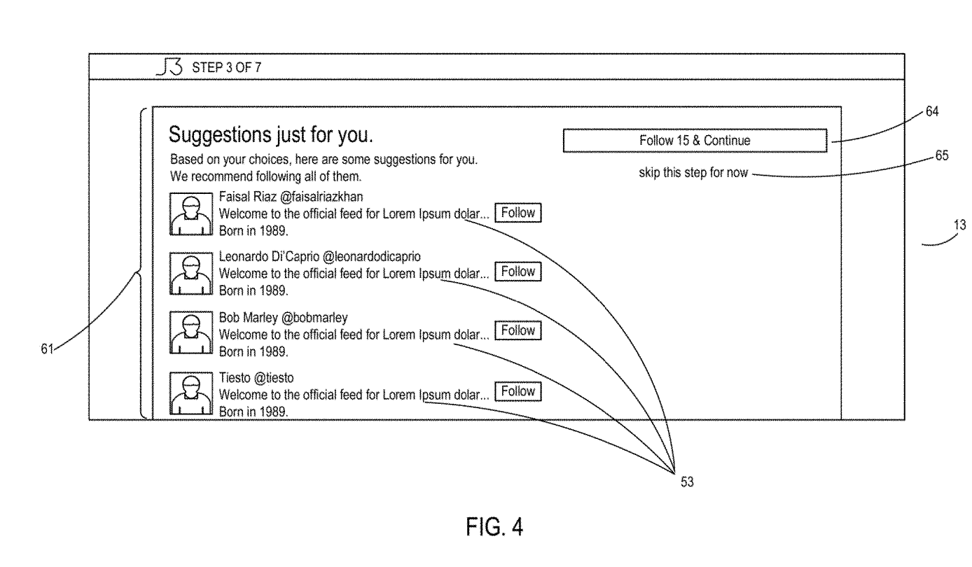

18. The method of any one of embodiments 14 to 17, further comprising: prior to displaying the user home page 20, for new users, providing a user interest page 12 that provides various interest choices 60 to the user; and in response to the user selecting one or more interest choices 60 on the user interest page 12, saving and associating the selected interest choices 60 with a user profile of the user; providing for display a list of suggested artists 61 to the user based on the selected interest choices 60 of the user; and providing (i) a first option for the user to select one or more of the suggested artists 53 to follow, and (ii) a second option to skip the first option and continue to a first user profile customization page 15. See, for example, exemplary user interest page 12 shown in FIG. 3, and an exemplary list of suggested artists page 13 shown in FIG. 4. As shown in exemplary user interest page 12 shown in FIG. 3, after a user selects one or more interest choices 60, the user may select the continue button 62 and continue to exemplary list of suggested artists page 13 shown in FIG. 4. Alternatively, the user may select the “select all and continue” button 63, which checks all of the interest choices 60 and continue to exemplary list of suggested artists page 13 shown in FIG. 4.

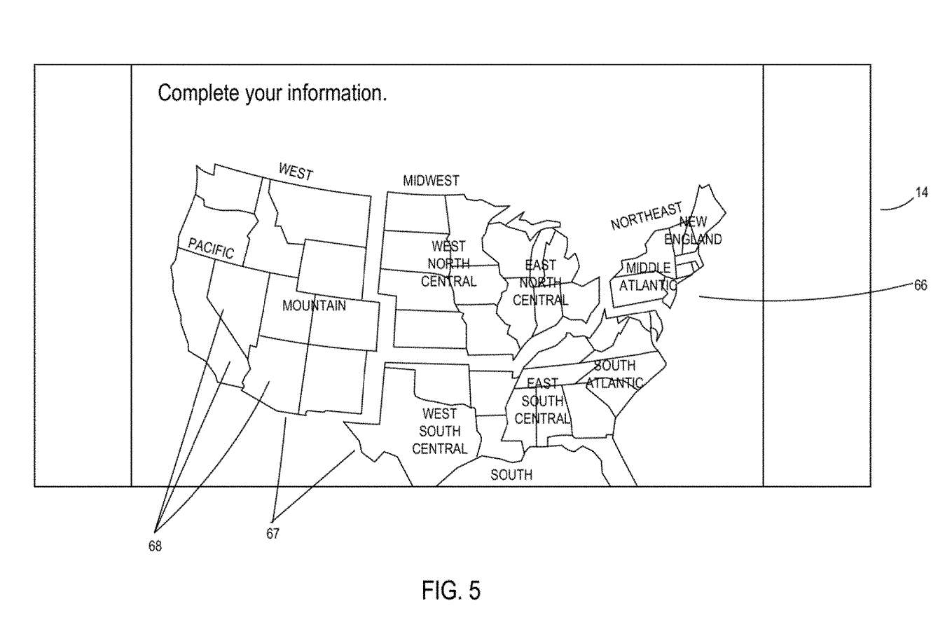

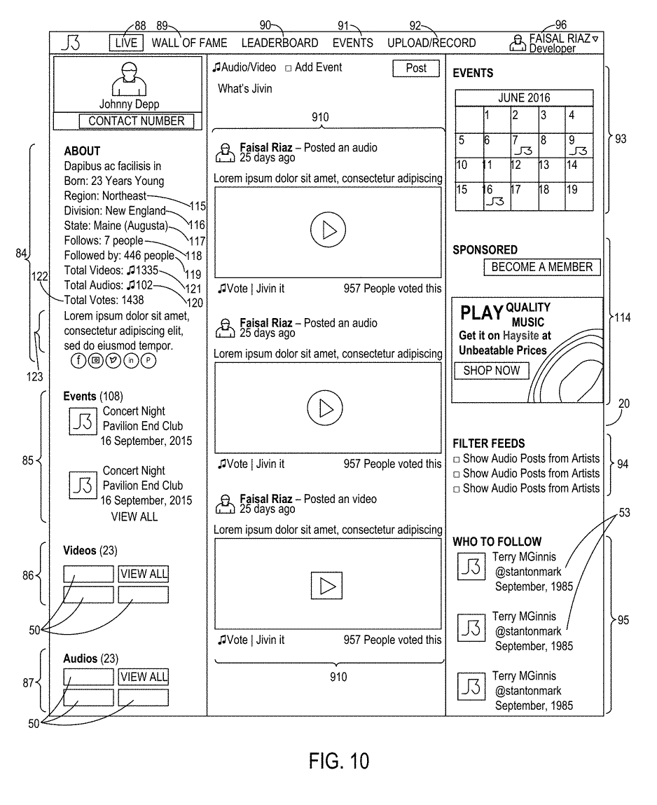

19. The method of embodiment 18, further comprising: in response to the user selecting the first option, saving and associating the selected suggested artists 53 to follow with a user profile of the user; incorporating a list of the selected suggested artists 53 to follow on the user home page 20 of the user; and continuing to the first user profile customization page 15. As shown in exemplary list of suggested artists page 13 shown in FIG. 4, after a user selects one or more suggested artists 53 to follow, the user may select the “follow and continue” button 64 and continue thru the new user registration process. Alternatively, the user may select the “skip this step for now” button 65, which continue thru the new user registration process directly to a user information map page such as exemplary user information map page 14 shown in FIG. 5. If the user selects the “skip this step for now” button 65, the user's home page 20 will not have any suggestions to follow (i.e., suggested artist follow list 95 shown in FIG. 10 will be empty), but the user would have the option to select interests (i.e., build their suggested artist follow list 95) from their home page 20. See again, exemplary home page 20 shown in FIG. 10.

20. The method of any one of embodiments 14 to 19, further comprising: prior to displaying the user home page 20, for new users, providing a user information map 66 for viewing by the user; and in response to the user selecting a region 67 on the user information map 66, saving and associating the selected region 67 with a user profile of the user; incorporating details of the selected region 67 on the user home page 20 of the user; and continuing to the first user profile customization page 15. See, for example, exemplary user information map page 14 shown in FIG. 5.

21. The method of embodiment 20, wherein the user information map comprises a map of the United States. See again, for example, exemplary user information map page 14 shown in FIG. 5. It should be understood that the herein-described methods and website may be used within any and all areas around the world, and are not limited solely to the United States as shown in FIG. 5.

22. The method of embodiment 20 or 21, wherein the user information map 66 comprises a map 66 of the United States that is divided into four regions 67, the four regions 67 being a west region, a midwest region, a south region, and a northeast region.

23. The method of embodiments 22, wherein each of the four regions 67 are further divided into individual states 68, and an individual state 68 is incorporated onto the user home page 20 of the user, when applicable (i.e., the user lives in the U.S.).

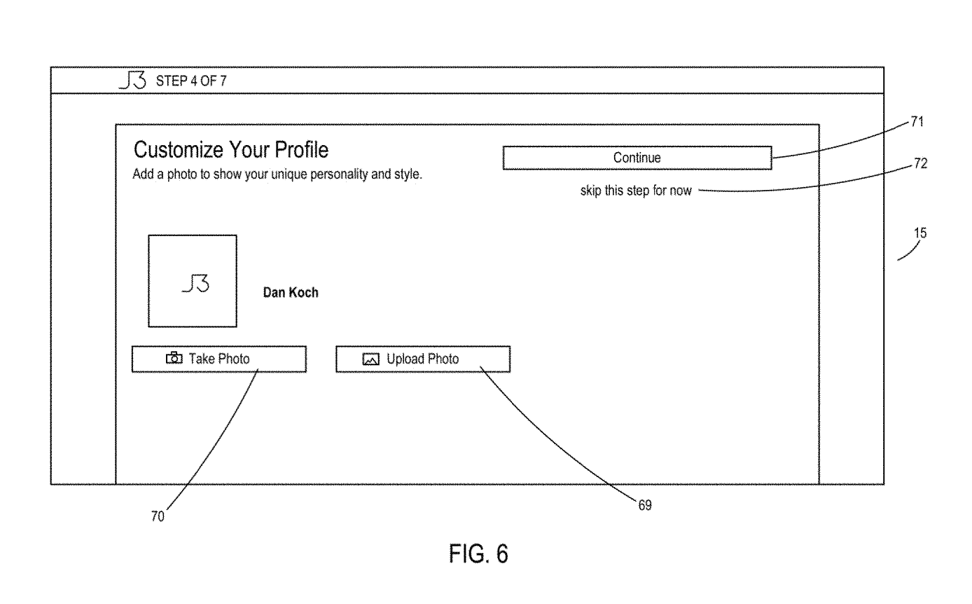

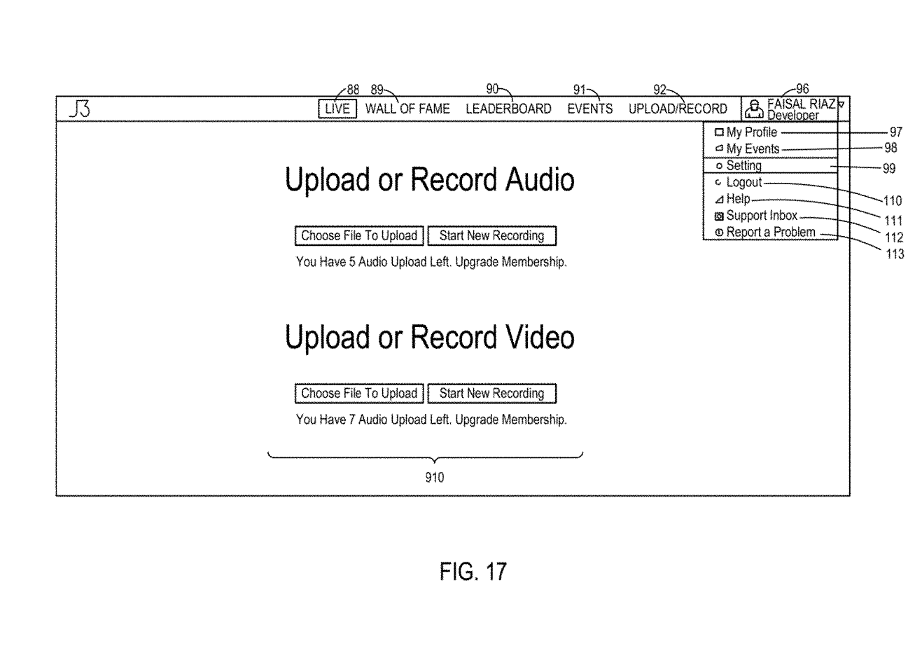

24. The method of any one of embodiments 14 to 23, further comprising: prior to displaying the user home page 20, for new users, providing a first user profile customization page 15 for viewing by the user; and on the first user profile customization page 15, providing (i) a first option for the user to upload an existing photograph into the user home page 20 (i.e., via “upload photo” button 69) (ii) a second option for the user to take a new photograph (i.e., via “take photo” button 70) and use the new photograph as a user identifier on the user home page 20, (iii) a third option for the user to continue to a second user profile customization page 16 (i.e., via the “continue” button 71 on exemplary first user profile customization page 15), and (iv) a fourth option to skip the first, second and third options and continue toward a user home page 20 (i.e., via the “skip this step for now” button 72 on exemplary first user profile customization page 15). See, for example, exemplary first user profile customization page 15 shown in FIG. 6. If a user selects the “skip this step for now” button 72, the user can upload or take a photo at a later time via, for example, the “my profile” option 97 of drop down box 96 shown in FIG. 17.

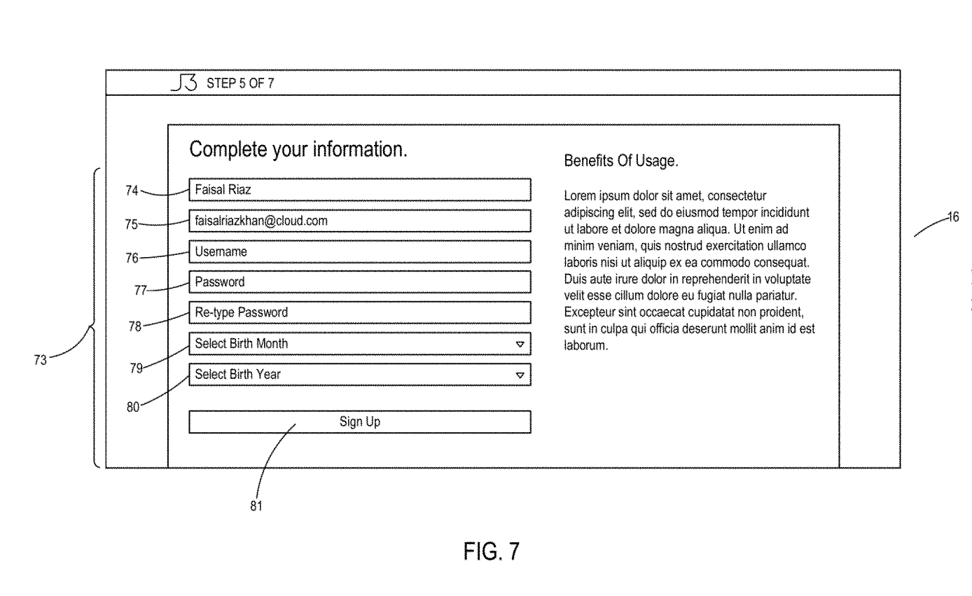

25. The method of any one of embodiments 14 to 24, further comprising: prior to displaying the user home page 20, for new users, providing a second user profile customization page 16 for viewing by the user; and on the second user profile customization page 16, providing for the user a list of information requests 73, the list of information requests 73 comprising (i) a user name (i.e., already copied from the earlier log-in step and placed in user name location 74), (ii) a user email address (i.e., already copied from the earlier log-in step and placed in user email address location 75), (iii) a username (i.e., chosen and inputted by the user into the username location 76), (iv) a user password (i.e., chosen and inputted by the user into the user password location 77), (v) re-entry of the user password (i.e., inputted by the user into the re-type password location 78), (iv) a birth month of the user (i.e., selected by the user via a month drop down menu 79), and (v) a birth year of the user (i.e., selected by the user via a year drop down menu 80); and in response to the user providing information in the list of information requests 73 and selecting a sign-up option (i.e., by clicking the “sign up” button 81), saving and associating the inputted information in the list of information requests with a user profile of the user; and incorporating details of the inputted information in the list of information requests 73 on the user home page 20 of the user. See, for example, exemplary second user profile customization page 16 shown in FIG. 7.

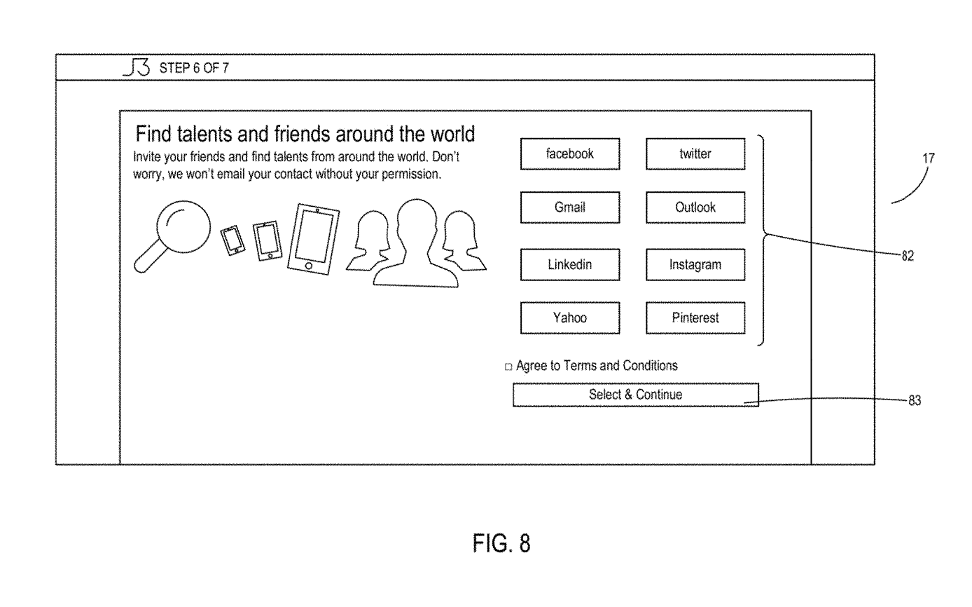

26. The method of any one of embodiments 14 to 25, further comprising: prior to displaying the user home page 20, for new users, providing a user profile notification page 17 for viewing by the user; and on the user profile notification page 17, providing for the user: (I) (1) a first option to send (i) a standard email message to one or more contacts/friends letting the one or more contacts/friends know that the user has a new Jivin.com user profile (via one of sending methods 82, e.g., GMAIL, TWITTER, etc.), and (ii) a link to the new Jivin.com user profile, and (2) a second option to send (i) a customized email message to one or more contacts/friends letting the one or more contacts/friends know that the user has a new Jivin.com user profile (via one of sending methods 82, e.g., GMAIL, TWITTER, etc.), and (ii) a link to the new Jivin.com user profile, and (II) a “terms and conditions agreement” selection button 83. See, for example, the possible features on exemplary user profile notification page 17 shown in FIG. 8.

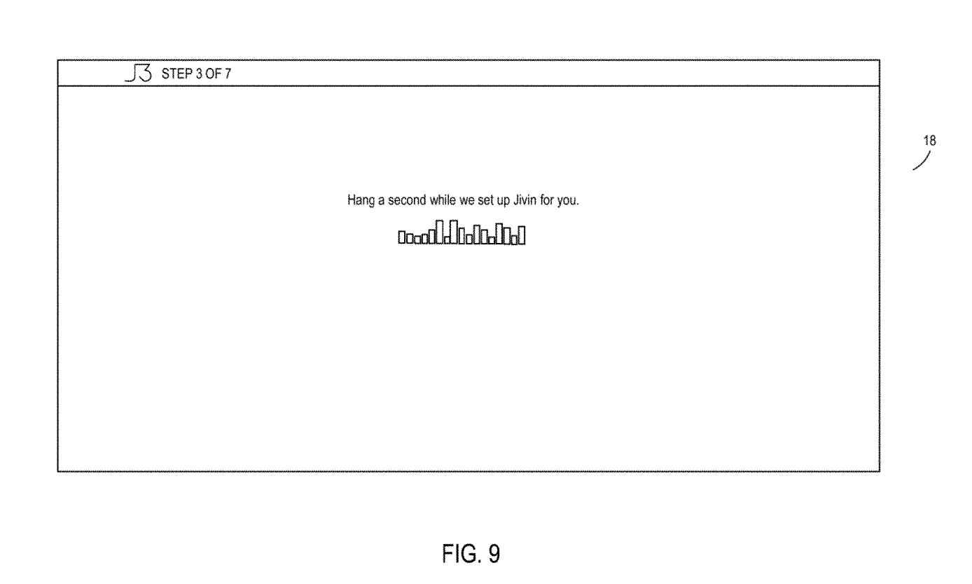

27. The method of embodiment 26, further comprising: prior to displaying the user home page 20 and after selecting the terms and conditions agreement selection 83, for new users, providing a user home page set-up in progress notification page 18 for viewing by the user while the website sets up a new user home page 20; and once the new user home page 20 is set up, continuing to the new user home page 20 for display to the user. See, for example, exemplary user home page set-up in progress notification page 18 shown in FIG. 9.

28. The method of any one of embodiments 1 to 27, further comprising: in response to an existing user, with a previously created user home page 20, inputting a previously stored user log-in name and a previously stored user password (i.e., within name entry location 54, and user password entry location 55 on exemplary website log-in page 10), displaying for the user the previously created user home page 20. See, for example, exemplary user home page 19 shown in FIG. 10.

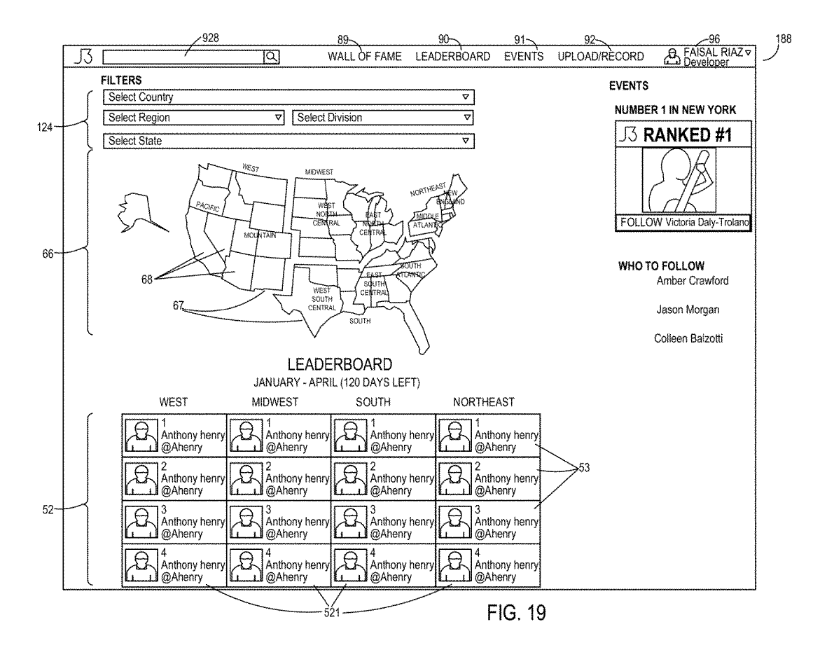

29. The method of any one of embodiments 1 to 28, wherein the user home page 20, once created, provides one or more of the following features for the user: (1) an about section 84 that provides information about the user; (2) an events section 85 that provides information about upcoming events flagged by the user; (3) a video section 86 that provides information about videos 50 that have been uploaded by the user; (4) an audio section 87 that provides information about audios 50 that have been uploaded by the user; (5) a live stats button 88 that enables the user to view up-to-date standings of the top X uploaded files 50 (e.g., the top 10 uploaded files) based on a total number of file votes received for each uploaded file 50, when available, during the first time period; (6) a wall of fame button 89 that enables the user to view wall of fame results 51 for the first time period that recently ended, the wall of fame results 51 depicting uploaded file winners for the first time period that recently ended; (7) a leaderboard button 90 that enables the user to view leaderboard results 52 for the second time period that recently ended, the leaderboard results 52 depicting artist winners 53 for the second time period that recently ended (See, for example, leaderboard page 188 shown in FIG. 19); (8) an events button 91 that enables the user to view upcoming events for one or more followed artists 53; (9) an upload/record button 92 that enables the user to upload or record a new file 50; (10) an events calendar 93 that enables the user to input details of upcoming events for one or more artists 53 followed by the user; (11) a filter feeds option 94 that enables the user to choose one or more specific feed options selected from (i) showing audio posts 50 from one or more selected artists 53, (ii) showing video posts 50 from one or more selected artists 53, (iii) showing status updated from one or more selected artists 53, and (iv) any combination of (i) to (iii); (12) a suggested artist follow list 95 that displays a list of artists 53 having similar interests as the user (i.e., as indicated by the user when first accessing jiving.com, namely, selected interest choices 60 on the user interest page 12); (13) a user name and drop down box 96 for the user, the drop down box 96 provided one or more of the following drop down options to the user: (i) a “my profile” option 97 that returns the user to their user home page 20, (ii) a “my events” option 98 that displays the user's scheduled upcoming events, (iii) a “settings” option 99 that displays a list of settings that may be changed by the user, (iv) a “logout” option 110 for logging out of the website, (v) a “help” option 111 that provided frequently asked questions (FAQ) and a support email address, (vi) a “support inbox” option 112 that provides the user with a list of email messages, (vii) a “report a problem” option 113 that provides the user with a way to report a problem with the website or any uploaded file 50, (viii) any combination of (i) to (vii); (14) a slideshow 114 that depicts a slideshow of all #1 winners 50/53 for the previous first time period and the previous second time period; (15) a posting section 910 within which (i) user(s) post comments, messages, etc., and (ii) various displays are provided depending on application functions selected by a user (e.g., the exemplary displays as shown in FIGS. 10-17); and (16) any combination of (1) to (15). See, for example, exemplary drop down option/menu 96 shown in FIG. 17. In addition, although not shown, a drop down menu (e.g., drop down box 96) can be designed to include a “feature tab” that lists all founding supporters and/or backers of the JIVIN™ platform and company. Even further, the drop down menu (e.g., drop down box 96) can also be designed to include a “JIVIN PRO™” option discussed herein (i.e., the option to subscribe to the paid membership of the JIVIN™ platform wherein a user/artist is able to upload/record any number of files 50). In some embodiments, the events tab/button 91 shows any upcoming event for all locations. In other embodiments, the events tab/button 91 shows upcoming events as filtered by the user (e.g., filtered by location, e.g., the city of Munich, or by artist, or by some other criteria, e.g., style of music). Further, each members' home page 20 can be designed to show the JIVIN™ logo, J3™, within calendar 93 on the day and month of each event performance. By clicking on a given J3™ logo, event details (e.g., artist, time, location, and direction) are provided to the user.

30. The method of any one of embodiments 1 to 29, wherein the user home page 20, once created, provides the about section 84 for display to the user, the about section 84 comprising one or more of the following features: (i) a region tab 115 associated with the user, the region tab 115, when selected, displaying for the user a list of the top Y artists 53 in the leaderboard rankings 52 from the region 67 associated with the user (e.g., the top 250 artists 53); (ii) a division tab 116 associated with the user, the division tab 116, when selected, displaying for the user a list of the top Y artists 53 in the leaderboard rankings 52 from the division (e.g., New England) associated with the user (e.g., the top 200 artists 53); (iii) a state tab 117 associated with the user, the state tab 117, when selected, displaying for the user a list of the top Y artists 53 in the leaderboard rankings 52 from the state 68 associated with the user (e.g., the top 100 artists 53); (iv) a follows tab 118 associated with the user, the follows tab 118, when selected, displaying for the user a list of all artists 53 that the user is following on the website; (v) a followed by tab 119 associated with the user, the followed by tab 119, when selected, displaying for the user a list of all artists 53 that follow the user on the website; (vi) a total audios tab 120 associated with the user, the total audios tab 120, when selected, displaying for the user a first written description of the audio files 50 uploaded by the user during the current second time period (e.g., current yearly quarter); (vii) a total videos tab 121 associated with the user, the total videos tab 121, when selected, displaying for the user a second written description of the video files 50 uploaded during the current second time period; (ix) a total votes 122 for the user during the current second time period; (x) a bio section 123 that displays a third written description of the user (i.e., any information about the user) prepared by the user; and (xi) and any combination of (i) to (x).

31. The method of any one of embodiments 1 to 30, wherein the user home page 20, once created, provides (i) the events section 85 and (ii) an events calendar 93 for display to the user, the events section 85 displaying any event that the user inputs into the events calendar 93.

32. The method of any one of embodiments 1 to 31, wherein the user home page 20, once created, provides the video section 86 for display to the user, the video section 86 displaying a limited number of videos 50 that have been uploaded by the user, the limited number of videos 50 being dependent on (i) whether the user is a paying member and, if so, (ii) a particular membership package purchased by the user. For example, a lower monthly membership fee may allow the user to show up to 10 videos 50 in the video section 86, while a higher monthly membership fee may allow the user to show up to 20 videos 50 in the video section 86, and a maximum monthly membership fee may allow the user to show all of the user's uploaded videos 50 in the video section 86.

33. The method of any one of embodiments 1 to 32, wherein the user home page 20, once created, provides the audio section 87 for display to the user, the audio section 87 displaying a limited number of audios 50 that have been uploaded by the user, the limited number of audios 50 being dependent on (i) whether the user is a paying member and, if so, (ii) a particular membership package purchased by the user. See membership fee examples above.

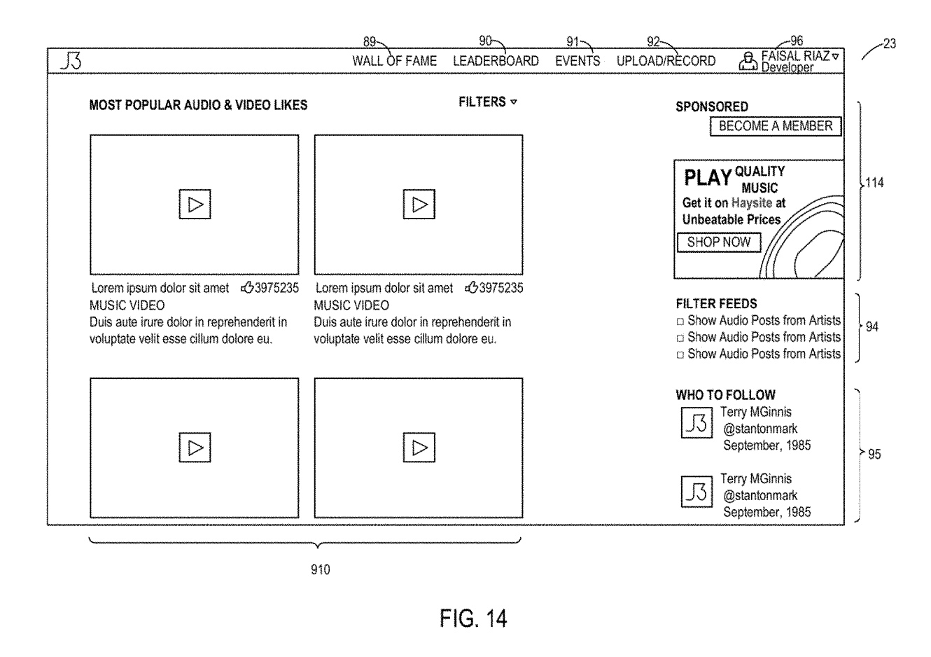

34. The method of any one of embodiments 1 to 33, wherein the user home page 20, once created, provides the live stats button 88, wherein the live stats button 88 automatically appears on the user home page 20 at a point in time midway within the first time period. When the live stats button 88 is selected, the method proceeds to a display of live stats within posting section 910 of a user's home page 20. See, for example, exemplary live stats display page 23 shown in FIG. 14.

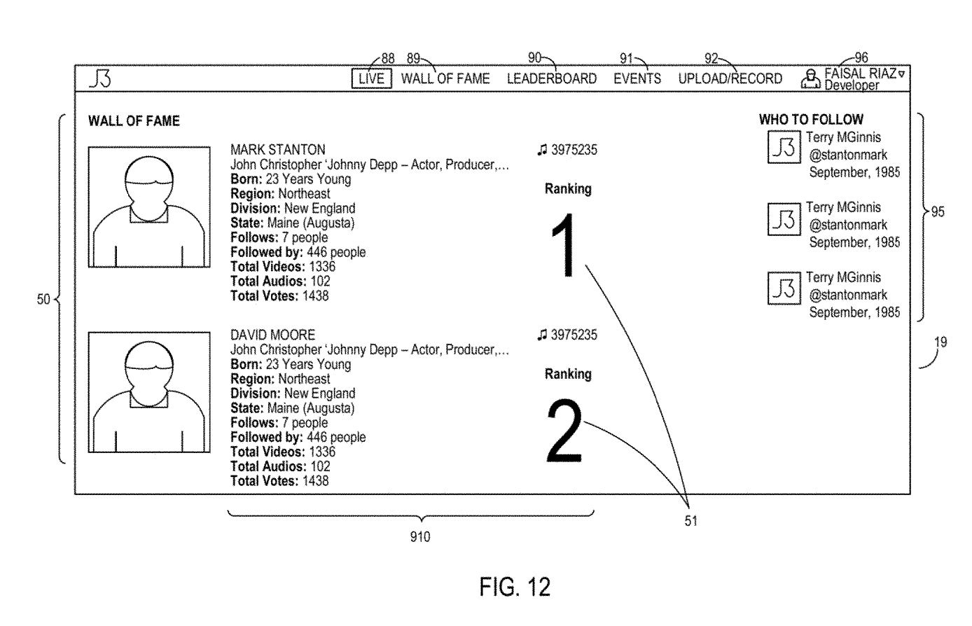

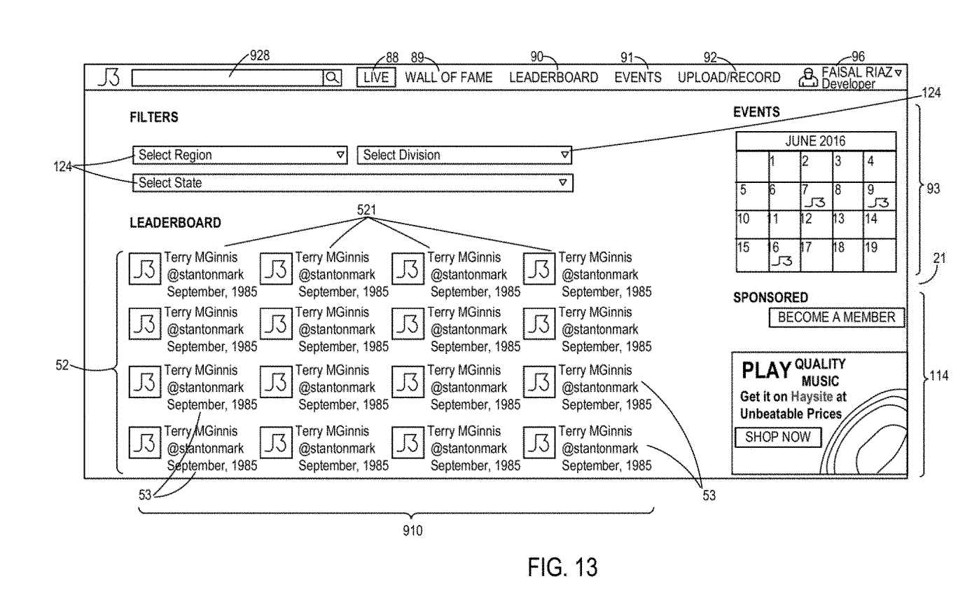

35. The method of any one of embodiments 1 to 34, wherein the user home page 20, once created, provides the wall of fame button 89. When the wall of fame button 89 is selected, the method proceeds to a wall of fame display such as exemplary wall of fame display 19 shown in FIG. 12. As shown in FIG. 14, exemplary wall of fame display 19 provides file rankings 51 of the top X uploaded files 50 based on a total number of file votes received for each uploaded file 50 within the previous first time period (e.g., the previous month of the year). Although not shown in FIG. 14, exemplary wall of fame display 19 also provides filters (i.e., similar to those shown on leaderboard display 21 in FIG. 13) that a user may use to show past wall of fame winners for each of the previous first time periods (e.g., winners of all of the previous months of the years). In addition to filter tabs for a select region, select division, and select state (see, filters 124 shown on leaderboard display 21 in FIG. 13), additional filters could be for (1) a given year or span of year, (2) artists 53 having the highest vote totals over the life of the JIVIN™ platform, (3) uploaded files 50 having the highest vote totals over the life of the JIVIN™ platform, etc.

36. The method of any one of embodiments 1 to 35, wherein the user home page, once created, provides the leaderboard button 90. When the leaderboard button 90 is selected, the method provide a leaderboard display such as exemplary leaderboard display 21 shown in FIG. 13. As shown in FIG. 13, exemplary leaderboard display 21 provides artists rankings 52 of the top Y artists 53 based on a total number of artist votes received for each artist 53 within the previous second time period (e.g., the previous calendar quarter of the year), the total number of artist votes corresponding to a sum of file votes for all uploaded files 50 by a given artist 53. As shown in FIG. 13, in this example, exemplary leaderboard display 21 provides winners 53 for four region, namely, the west, midwest, south, and northeast regions of the United States shown in adjacent columns 521. Exemplary leaderboard display 21 also provides filters 124 that a user may use to show past artist winners for each of the previous second time periods (e.g., artist winners of all of the previous quarters of the years). Further, filters 124 may be used by a user to show past artist winners for each of the previous second time periods (e.g., artist winners of all of the previous quarters of the years) from specific regions 67, divisions, and/or states 68. As discussed above, in addition to filters 124 shown on leaderboard display 21 in FIG. 13, additional filters could be for (1) a given year or span of year, (2) artists 53 having the highest vote totals over the life of the JIVIN™ platform, (3) uploaded files 50 having the highest vote totals over the life of the JIVIN™ platform, etc. Further, in addition to filters 124 shown on leaderboard display 21 in FIG. 13, search feature 928 may be used to search for a specific artist 53 or a specific uploaded file 50 (or any other word or combination of words) within the current leaderboard or a previous leaderboard. Another exemplary leaderboard page 188 is shown in FIG. 19. In addition to features discussed above in exemplary leaderboard display 21 shown in FIG. 13, exemplary leaderboard page 188 also shows map 66, and the top ten (10) artists within each of the four regions of the U.S., namely, the west, midwest, south, and northeast regions of the United States shown in adjacent columns 521.

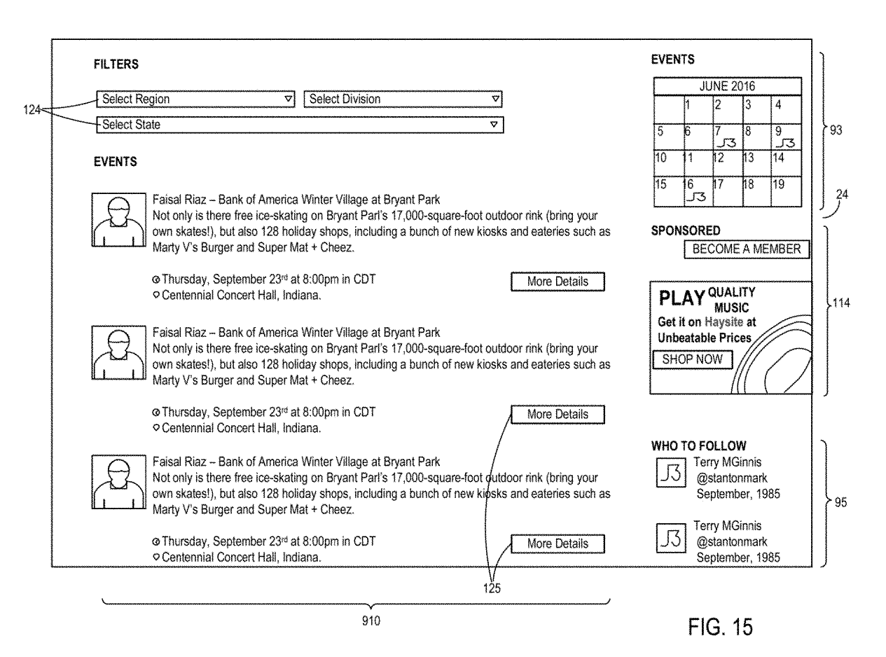

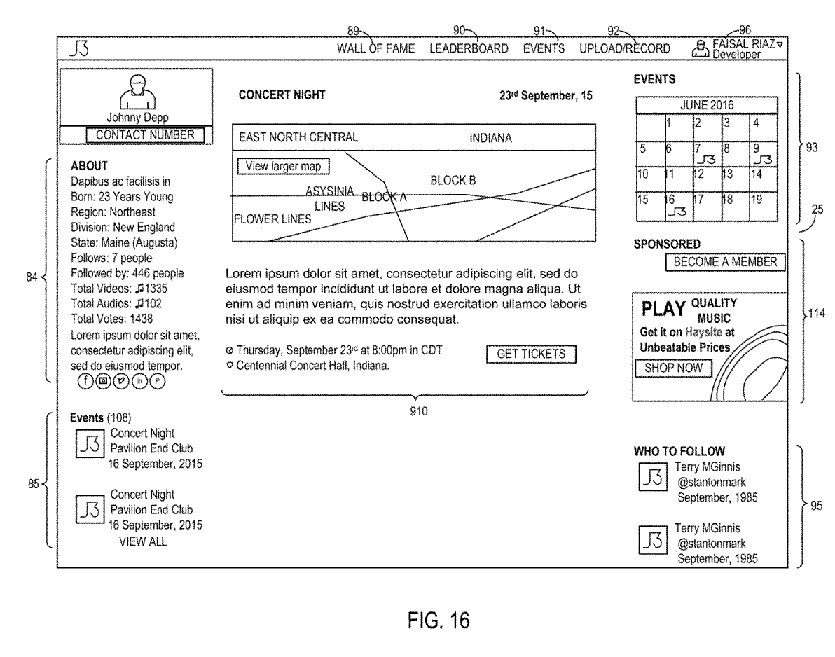

37. The method of any one of embodiments 1 to 36, wherein the user home page 20, once created, provides the events button 91. When the events button 91 is selected, the method provides the following options to a user: (1) add an event, (2) search an event or (3) through a selection of filter tabs, find all upcoming events for a particular location. The events button 91 provides all the features to find any event in any area under one tab and one website that actually relates to all the events taking place, not being just a directory. As shown in FIG. 15, one option provides an events page display such as exemplary events page display 24. When a particular event on events page display 24 is selected (i.e., via a “more details” button 125), the method proceeds to a detailed event display such as exemplary detailed event display 25 shown in FIG. 16.

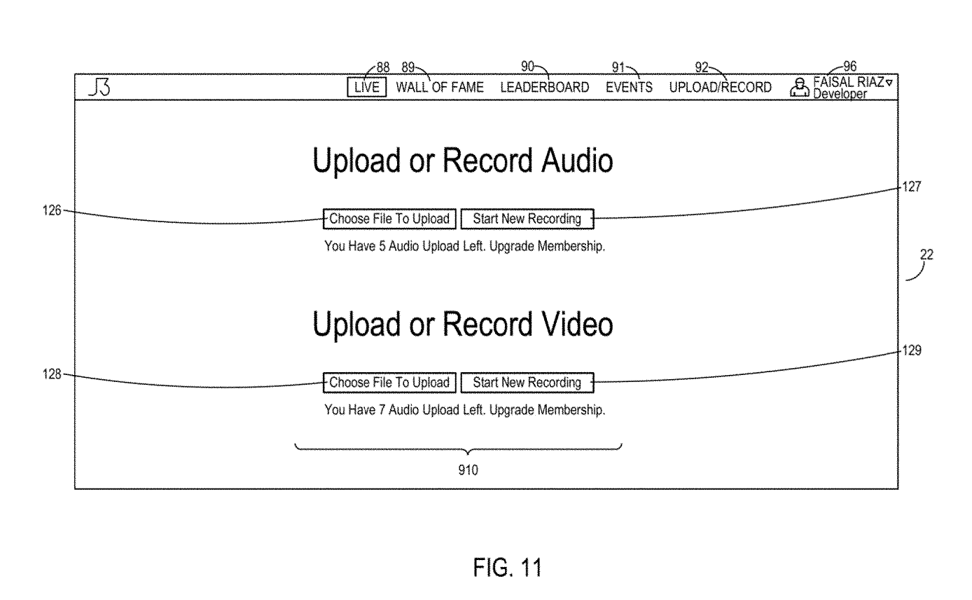

38. The method of any one of embodiments 1 to 37, wherein the user home page 20, once created, provides the upload/record button 92 that enables the user to view upload or record a new file 50. When the upload/record button 92 is selected, the method proceeds to an upload/record page display such as exemplary upload/record page display 20 shown in FIG. 11. As shown in FIG. 11, exemplary upload/record page display 20 provides a user with the following options: (i) upload an existing audio file 50 via the “choose and upload” button 126, (ii) record a new audio file 50 via the “start new recording” button 127, (iii) upload an existing video file 50 via the “choose and upload” button 128, (ii) record a new video file 50 via the “start new recording” button 129.

39. The method of any one of embodiments 1 to 38, wherein the user home page 20, once created, provides the filter feeds option 94.

40. The method of any one of embodiments 1 to 39, wherein the user home page 20, once created, provides the suggested artist follow list 95.

41. The method of any one of embodiments 1 to 40, wherein the user home page 20, once created, provides the user name and drop down box/menu 96 for the user.

42. The method of any one of embodiments 1 to 41, wherein the user home page 20, once created, provides the slideshow 114. Slideshow 114 will provide a slideshow of previous months winners on the Wall of Fame display. In some embodiments, only the #1 winners 53 of the previous month will show. The winning members 53 profile photo will show along with the state, division, region or country that they won. Obviously if a member or artist 53 was #1 in a given country (e.g., the US), then their profile photo will show as many as four times, being the artist 53 is the winner, for example, in the state, division, region and country. Also, in some embodiments, the profile photos of the past three month Leaderboard #1 winners will show as well. The profile photos will come in and out (i.e., via the slideshow) on every JIVIN™ members home page 20, creating instant marketing ability for a winning artist 53 of the JIVIN™ platform.

43. The method of any one of embodiments 1 to 41, wherein the user home page 20, once created, provides a posting section 910 within which (i) user(s) post comments, messages, etc., and (ii) various displays are provided depending on application functions selected by a user (e.g., the exemplary displays as shown in FIGS. 10-17).

44. The method of any one of embodiments 29 to 43, wherein the wall of fame display 19 displays the file ranking 51 of the top X uploaded files 50, based on a total number of file votes received for each uploaded file 50, for the previous first time periods (e.g., all previous months). See, for example, exemplary wall of fame display 19 shown in FIG. 12.

45. The method of any one of embodiments 29 to 44, wherein the leaderboard display 21 displays the top Y artists 53, based on the total number of artist votes received for each artist 53, for the previous second time periods (e.g., all previous calendar quarters). See, for example, exemplary leaderboard display 22 shown in FIG. 13. As discussed above, in some embodiments, the leaderboard displays artists having the greatest sum of all votes within a given three month competition. In this embodiment, once the three month ends, a new competition starts, and all of the votes within the previous three months for each file goes back to zero (0). Further, in this embodiment, the files can still accumulate votes, but the votes will go towards the new three month competition and the new one month wall of fame competition, but individually for that competition.

46. A method of using web-based systems for providing online competitions and live stats for artists, performers and other talents, the method comprising: any of the method steps recited in any one of embodiments 1 to 45.

### Computer Application Embodiments

47. A computer application 140 capable of being loaded onto a web-based computer system 141, said computer application 140 comprises software code that enables performance of the method of any one of embodiments 1 to 46.

48. The computer application 140 of embodiment 47, wherein the computer application 140 is a downloadable computer application available via the Internet 142.

49. The computer application 140 of embodiment 47, wherein the computer application 140 is loaded onto a computer application media (e.g., disc, flash drive, etc.) (not shown) that can be inserted into a port on a computer 143.

### Computer System Embodiments

50. A computer system 200 comprising: a network interface 143; and a processor 144 in communication with the network interface 143, the processor 144 being configured to perform the method of any one of embodiments 1 to 46.

51. The computer system 200 of embodiment 50, wherein said network interface 143 comprises one or more computing devices 143, said one or more computing devices 143 comprising one or more laptops (not shown), one or more desktop computers 143, one or more smart phones (not shown), or any combination thereof.

52. The computer system 200 of embodiment 50 or 51, wherein said processor 144 comprises a web server 145 on which the computer application 140 is loaded.

53. The computer system 200 of any one of embodiments 50 to 52, further comprising a database server 148, said database server 148 being configured to store any data 146 managed and/or utilized by the computer application 140.

54. The computer system 200 of any one of embodiments 50 to 53, further comprising a backup storage server 149, said backup storage server 149 being configured to store a backup copy of all data 146 managed and/or utilized by the computer application 140.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLE 1

### Preparation of The JIVIN.COM Web-based Software Application

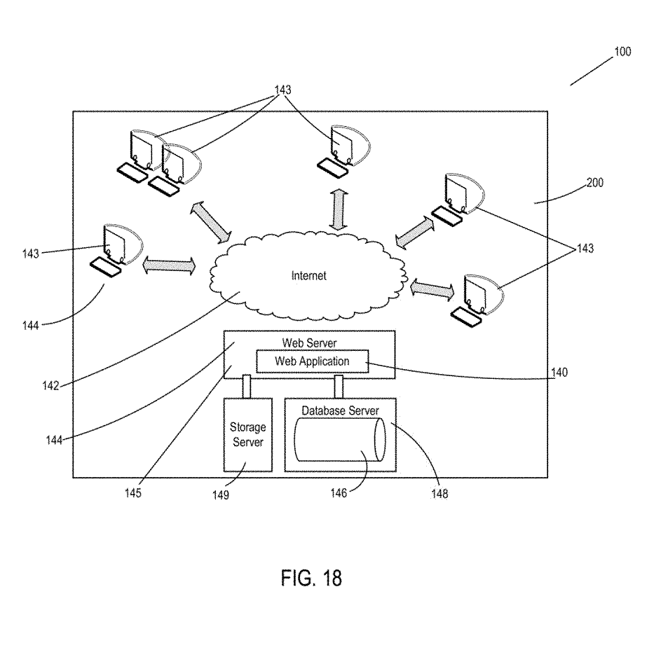

The JIVIN.COM web-based software applications comprising details similar to those shown in FIGS. 1-18 were prepared and utilized on various computing systems.

In one example, the JIVIN.COM web-based software was designed for utilization in the United States. In this example, the JIVIN.COM web-based software tracked artist feedback/competition for (i) the country (i.e., the United States), (ii) the four regions of the United States, (iii) nine divisions of the United States, and (iv) all fifty states so as to provide 64 separate live stats and rankings running simultaneously. These 64 separate live rankings and live stats were displayable within (1) the Wall of Fame Competition (i.e., showing the uploaded/recorded files 50 having the highest number of votes within each of the 64 areas) and (2) within the Leaderboard Competition (i.e., showing the artists 53 having the highest number of votes within each of the 64 areas), totaling 128 live rankings and live stats always available on JIVIN.COM.

### EXAMPLE 2

### Exemplary Revenue/Advertising Components of The JIVEN.COM Web-based Software Application

The JIVIN.COM web-based software applications may further comprise any of the details discussed below.

### Basic Member Feature

By being a “Basic Member,” the JIVIN.COM web-based software applications may allow the user to do one or more of the following:
Can post a total of 3 audios or 3 videos or a combination of either up to 3
The audio and/or video can be a maximum of 1 minute long each
After a Basic member reaches their limit, a pop up box will appear with the following information. It will say that you need to upgrade to Jivin Pro to continue posting audios and videos.
They can follow other members and members can follow them.
They can Vote for other members audios & videos just like a paid member can
They can view all tabs and navigate throughout the site just like a paid member can
They can follow a maximum of 2000 members. The only way they can follow more is if they have at least 25% of the total they are following follows them. Example would be if a basic member is following 2000 members, than 500 ppl must be following them in order to follow more people.
They can upload any number of pictures, unlimited amount
They can post as much as they want, meaning a typing post, not audio or video post.
They can use the “Jive-It” option to repost other members audios or videos that they liked as many times as they want.

### Jivin Pro Member

By being a “Jivin Pro Member,” the JIVIN.COM web-based software applications may allow the user to do one or more of the following for a fee, as shown below:
$8.99 Recurring Monthly Charge (or any other agreed upon charge)
Can post any number of audio or videos, no limit to the amount for a paid member
The audios and videos can be a maximum of 3 minutes each!
They can use every part of the website!
They can follow any amount of members with no limit as to how many must follow them!
They can Vote for other members audios or videos
They can upload any number of pictures, unlimited amount
They can post as much as they want, whether it is typing posts or the audios and or videos
Most important though, they have access to the advertising section.
A Jivin Pro Members has the access to bid to market themselves through Member Marketing Options listed under the Advertising Column.

### Advertisements for Jivin Pro Members

By being a “Jivin Pro Member,” the JIVIN.COM web-based software applications may also allow the user to have/utilize one or more of the following:
Member Promotion Ad—
Member Promotion Video Ad—
Member 30 Second Video Ad (Wall of Fame)—Top 5 leading up to winner's month end
Member Promoted Audio/Video

### Member Promotion Ads

A “Member Promotion Ad” is a short description linked up to a user's homepage. You can put a maximum of 3 photos on your promoted ad along with your member name and a short bio of yourself The 3 photos will appear on a rectangular ad that will show on all Jivin Members live feed during certain hours or times of the day. Your ad will appear based on the maximum bid you place to have your ad during the certain times of the day. If your ad has the highest bid, then it will show during the time it received the highest bid. The idea for a member to use a Promotional Ad for themselves is to obtain more followers. The more followers they get, the more chances of votes they will receive for each audio or video that they post. It's a great way to market yourself with Jivin! A member promotion ad runs 4 times every hour.

The ad will run at the top of the hour, 15, 30 and 45 minutes of the hour. A member can bid how much they are willing to spend on an ad on a per day basis or use the advanced option and actually break it down by the hour. Advanced option will give the member to option of placing a higher bid for let's say 1 pm, but can also place a no option bid for 3 am. This will prevent members spending marketing money in the middle of the night when less users may be on and also let them spend what they are willing during peak usage time.

### Member Promotion Video Ad

It is the exact same ad as listed above, except that a member pays an additional fee to have a 30 second video as the ad itself Any member can then click on the video to see a short video of that artist and also then go to that member's homepage. The Promoted Video ad can be any video or audio that has already been posted, then the member just chooses a 30 second portion of the audio or video to be used as the advertisement for themselves. This is another great way for a Jivin member to market themselves and obtain followers. To post a Video Ad, the additional cost is only $5.00 (or thereabouts) and that video can be used as many times as they want moving forward. The Member Promotion Video Ad will coordinate its function with the above listed member promotion ad. If a member has a higher bid for the 1 pm hour and it is a member promoted ad, then that ad will show. If a bid for a promoted video is higher for a certain hour, then that video will show.

### 30 Second Member Video Ad

This ad will be more costly for members, because the amount of views they will receive will be more than any other advertising option on the site. This is an audio or video only option. You will have the choice of bidding for either the first 30 second ad that will run before a Wall of Fame audio or video leader will show and you will bid for the ad that runs after the audio or video ends. This ad will have a lot more Value because you are bidding on a per day viewing instead of a per day or per hour option like the other ads. Let's say you place a $100 bid per day max for you 30 second video or audio to be on the wall of fame and you win one of the days, then for every jivin member who clicks the leading songs for a specific 24 hours in a day, your audio or video will appear. This is another awesome way to promote yourself on Jivin.

### Paid Advertising Features

Audience:

| | |
|---|---|
| State | $100.00 |
| Division | $900.00 |
| Region | $0.00 |
| Country | $0.00 |

With the dollar amounts for the above listed, let me give you an example of what I'm thinking. Let's say a user puts $1000 into their account, which brings up a point that an account for each member needs built for advertising spending. Now going back to my point. Look at the above numbers. How would you interpret this relating to the information listed below? For the above, this particular member has deposited $1000 into his account and has chosen to only advertise in his particular state and the division of his location. He/she has allocated $100 towards in state advertisements and $900 towards the division. The below information will go towards each area of state and division. On the backend for programming, for every member that bids their state, then those bids compete, every member for division those bids compete and so on. Once the $100 is used up for the state, then the $900 towards division advertising will compete against those bids with the below information.

Budget and Duration Time:

| | |
|---|---|
| Total Budget | $1,000.00 |
| Duration Time | 1 Day, 7 days, 14 days, 30 days, |
| Estimated Members Reached 0 | of 100,000 possible |

Paying for your ad options: Credit Card, Paypal, etc.

Ad account information: Country, Currency, etc.

Locations: This is the above information—See Audience above

Every hour of the day. Desirably, a chart is provided that has the 24 hours of the day. A member should be able to either say my maximum bid is $20 per hour for my ad. Then any opening per hour for the day where no else bidded more than $20, then they would get that time slot. Now, an advanced option would be for a member to actually place their bid on each hour of the time slot. Let's say the user is willing to spend $40 for any hour from 12 pm-6 pm, but does not want an ad running at any other time of the day. The user could put down $40 for the hours of 1 pm, 2 pm, 3 pm, 4 pm, 5 pm, & 6 pm. For the rest of the hours, the user would fill in $0 or an option that says do not run add. Then, if at the end of the duration the money has been used, it will automatically reload for the original charged balance or if it is unused, the member will receive a message stating “you have “X” Amount of Dollars left to spend, how would you like to proceed?”

### Ways for User to Become Known to the World

Become a Jivin Pro Member—If you're really serious about getting yourself known, you have to have the ability to upload your audios and videos so your followers can become a fan Take full advantage of the Advertising options for the Jivin Pro Members—Once again, if you're really serious about becoming known, then you have to get yourself out there. The best way to do this is get as many followers as you can. The more followers you get, the more opportunity to obtain votes.

Remember, the more votes you get, which include every audio or video that you post, the votes add to a total which ranks you on the leaderboard. As you begin to climb the leaderboard, other jivin members from around the country and around the world will notice and you will obtain even more followers and more votes. The idea behind this is, STAY ACTIVE, KEEP POSTING!!!

Always strive to land a top 3 spot on the Wall of Fame. Remember the Wall of Fame is the top 3 per state, top 3 per division and top 3 in the region the top 3 in the country. The wall of fame is the total votes per single video or single audio. The idea behind this is too post early in the month and if you have something that is popular and receiving the votes, then push that as much as you can. If you have a popular audio or video, us the Member Promoted Video Ad to get that song known. Put in the ad something like “Please listen to my song and help get me to the top 3 in my state.” Remember, all it takes is for you to be in the top 3 just one time and your picture with your title of the audio or video will for FOREVER saved to that wall of fame for that particular month. You will FOREVER receive more followers which will obtain more votes as long as you're a Jivin member.

Also, if you happen to land that #1 spot on the wall of fame for your state, your profile pic will rotate with the other #1 winners of each state on every single Jivin Members homepage for the entire month after winning. This will be the area on the homepage where it currently shows the advertisement for the speaker. Let's say we are in December. Well, where that ad is, it should show ONLY the #1 Wall Of Fame Winners from the previous month, meaning November. It will say, #1 in Connecticut, #1 Florida, #1 Ohio, etc. How cool is that! Just think, one hit audio or hit video can really make you a star overnight. Jivin is amazing and with it, a Jivin Pro Member has all the access to be discovered!

It should be understood that although the above-described methods, computer applications and computer systems are described as “comprising” one or more components, features or steps, the above-described methods, computer applications and computer systems may “comprise,” “consists of,” or “consist essentially of” any of the above-described components, features or steps of the methods, computer applications and computer systems. Consequently, where the present invention, or a portion thereof, has been described with an open-ended term such as “comprising,” it should be readily understood that (unless otherwise stated) the description of the present invention, or the portion thereof, should also be interpreted to describe the present invention, or a portion thereof, using the terms “consisting essentially of” or “consisting of” or variations thereof as discussed below.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a method, computer application and/or computer system that “comprises” a list of elements (e.g., components, features or steps) is not necessarily limited to only those elements (or components or steps), but may include other elements (or components or steps) not expressly listed or inherent to the method, computer application and/or computer system.

As used herein, the transitional phrases “consists of” and “consisting of” exclude any element, step, or component not specified. For example, “consists of” or “consisting of” used in a claim would limit the claim to the components, features or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a method, computer application and/or computer system that includes steps, features, components, or elements, in addition to those literally disclosed, provided that these additional steps, features, components, or elements do not materially affect the basic and novel characteristic(s) of the claimed invention. The term “consisting essentially of” occupies a middle ground between “comprising” and “consisting of”.

Further, it should be understood that the herein-described methods, computer applications and/or computer systems may comprise, consist essentially of, or consist of any of the herein-described components and features, as shown in the figures with or without any feature(s) not shown in the figures. In other words, in some embodiments, the methods, computer applications and/or computer systems of the present invention do not have any additional features other than those shown in the figures, and such additional features, not shown in the figures, are specifically excluded from the methods, computer applications and/or computer systems. In other embodiments, the methods, computer applications and/or computer systems of the present invention do have one or more additional features that are not shown in the figures.

In addition, it should be understood that the herein-described methods, computer applications and/or computer systems may further comprise, consist essentially of, or consist of various forms of competition, some of which may require a user to purchase a “ticket” for monetary value in order to enter a given competition. This “ticket” competition would be similar to a competition like American Idol, as seen on television, where the top performers move on to second and third (or any number) rounds of competition, and other members are eliminated within each round; however, the “ticket” competition would be online and comprise many of the features described above. This “ticket” competition would also resemble a voluntary competition wherein, if a user enters the competition, the user is (1) matched up against another artist, and (2) allowed a certain timeframe in which to enter one or more uploaded files 50. Then, voting would take place for a fixed period of time, and the user receiving the most votes within the fixed time period would move on to the next round. While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method of providing on-line feedback to artists via a web-based system, said method comprising:
providing a website that allows an artist to upload one or more files, wherein each uploaded file comprises visual content, audio content, or both visual and audio content;
allowing access to the website so that a user can vote for one or more of the uploaded files; and
in response to one or more requests by the artist or the user, displaying for view, on one or more webpages of the website, (1) a file ranking of the top X uploaded files based on a total number of file votes received for each uploaded file within a first time period, and (2) an artist ranking of the top Y artists based on a total number of artist votes received for each artist within a second time period, the total number of artist votes corresponding to a sum of file votes for all uploaded files by a given artist.

2. The method of claim 1, wherein the uploaded file comprises a music video, a dance video, or a combination thereof

3. The method of claim 1, wherein X is an integer ranging from 3 to 10, and Y is an integer ranging from 3 to 250.

4. The method of claim 1, wherein the second time period is longer in time than the first time period.

5. The method of claim 1, wherein the first time period is one month, and the second time period is three months.

6. The method of claim 1, further comprising:
offering a paid subscription to the website; and
in response to the artist paying for the paid subscription, allowing the artist to upload an unlimited number of uploaded files.

7. The method of claim 6, wherein, prior to paying for the paid subscription, the artist is limited to uploading one or more uploaded files with a total number of uploaded file minutes of up to Z minutes.

8. The method of claim 7, wherein, prior to paying for the paid subscription, the artist is limited to uploading one or more uploaded files with a total number of uploaded file minutes of up to 3.0 minutes.

9. The method of claim 1, further comprising:
providing a website log-in page so as to enable input of a user log-in name and user password; and
in response to the user log-in name and the user password inputted by the user, displaying for the user a user home page that provides access to multiple functions of the website.

10. The method of claim 9, further comprising:
prior to displaying the user home page, for new users, providing a user welcome page that welcomes the user to the website.

11. The method of claim 9, further comprising:
prior to displaying the user home page, for new users, providing a user interest page that provides various interest choices to the user; and
in response to the user selecting one or more interest choices on the user interest page,
saving and associating the selected interest choices with a user profile of the user;
providing for display a list of suggested artists to the user based on the selected interest choices of the user; and
providing (i) a first option for the user to select one or more of the suggested artists to follow, and (ii) a second option to skip the first option and continue to a user profile customization page.

12. The method of claim 11, further comprising:
in response to the user selecting the first option,
saving and associating the selected suggested artists to follow with a user profile of the user;
incorporating a list of the selected suggested artists to follow on the user home page of the user; and
continuing to the user profile customization page.

13. The method of claim 9, further comprising:
prior to displaying the user home page, for new users, providing a user information map for viewing by the user; and
in response to the user selecting a region on the user information map,
saving and associating the selected region with a user profile of the user;
incorporating details of the selected region on the user home page of the user; and
continuing to the user profile customization page,
wherein the user information map comprises a map of the United States that is divided into four regions, the four regions being a west region, a midwest region, a south region, and a northeast region.

14. The method of claim 9, further comprising:
prior to displaying the user home page, for new users, providing a first user profile customization page for viewing by the user;
on the first user profile customization page, providing (i) a first option for the user to upload an existing photograph into the user home page, (ii) a second option for the user to take a new photograph and use the new photograph as a user identifier on the user home page, (iii) a third option for the user to continue to a second user profile customization page, and (iv) a fourth option to skip the first, second and third options and continue to a user home page;
providing a second user profile customization page for viewing by the user; and
on the second user profile customization page, providing for the user a list of information requests, the list of information requests comprising (i) a user name, (ii) a user password, (iii) re-entry of the user password, (iv) a birth month of the user, and (v) a birth year of the user; and
in response to the user providing information in the list of information requests and selecting a sign-up option,
saving and associating the inputted information in the list of information requests with a user profile of the user; and
incorporating details of the inputted information in the list of information requests on the user home page of the user.

15. The method of claim 14, further comprising:
prior to displaying the user home page and after selecting the terms and conditions agreement selection, for new users, providing a user home page set-up in progress notification page for viewing by the user while the website sets up a new user home page; and
once the new user home page is set up, continuing to the new user home page for display to the user.

16. The method of claim 1, further comprising:
in response to an existing user, with a previously created user home page, inputting a previously stored user log-in name and a previously stored user password, displaying for the user the previously created user home page.

17. The method of claim 1, wherein the user home page, once created, provides one or more of the following features for the user:
(1) an about section that provides information about the user;
(2) an events section that provides information about upcoming events flagged by the user;
(3) a video section that provides information about videos that have been uploaded by the user;
(4) an audio section that provides information about audios that have been uploaded by the user;
(5) a live stats button that enables the user to view up-to-date standings of the top X uploaded files based on a total number of file votes received for each uploaded file, when available, during the first time period;
(6) a wall of fame button that enables the user to view wall of fame results for the first time period that recently ended, the wall of fame results depicting uploaded file winners for the first time period that recently ended;
(7) a leaderboard button that enables the user to view leaderboard results for the second time period that recently ended, the leaderboard results depicting artist winners for the second time period that recently ended;
(8) an events button that enables the user to view upcoming events for one or more followed artists;
(9) an upload/record button that enables the user to view upload or record a new file;
(10) an events calendar that enables the user to input details of upcoming events for one or more artists followed by the user;
(11) a filter feeds option that enables the user to choose one or more specific feed options selected from (i) showing audio posts from one or more selected artists, (ii) showing video posts from one or more selected artists, (iii) showing status updated from one or more selected artists, and (iv) any combination of (i) to (iii);
(12) a suggested artist follow list that displays a list of artists having similar interests as the user (i.e., as indicated by the user when first accessing jiving.com);
(13) a user name and drop down box for the user, the drop down box provided one or more of the following drop down options to the user: (i) a my profile option that returns the user to their use home page, (ii) a my events option that displays the user's scheduled upcoming events, (iii) a settings option that displays a list of settings that may be changed by the user, (iv) a logout option for logging out of the website, (v) a help option that provided frequently asked questions (FAQ) and a support email address, (vi) a support inbox option that provides the user with a list of email messages, (vii) a report a problem option that provides the user with a way to report a problem with the website or any uploaded file, (viii) any combination of (i) to (vii);
(14) a slideshow that depicts a slideshow of all #1 winners for the previous first time period and the previous second time period;
(15) a posting section within which (i) user(s) post comments, messages, etc., and (ii) various displays are provided depending on application functions selected by a user; and
(16) any combination of (1) to (15).

18. The method of claim 1, wherein the user home page, once created, provides the about section for display to the user, the about section comprising one or more of the following features: (i) a region tab associated with the user, the region tab, when selected, displaying for the user a list of the top Y artists in the leaderboard rankings from the region associated with the user; (ii) a division tab associated with the user, the division tab, when selected, displaying for the user a list of the top Y artists in the leaderboard rankings from the division associated with the user; (iii) a state tab associated with the user, the state tab, when selected, displaying for the user a list of the top Y artists in the leaderboard rankings from the state associated with the user; (iv) a follows tab associated with the user, the follows tab, when selected, displaying for the user a list of all artists that the user is following on the website; (v) a followed by tab associated with the user, the followed by tab, when selected, displaying for the user a list of all artists that follow the user on the website; (vi) a total audios tab associated with the user, the total audios tab, when selected, displaying for the user a first written description of the audio files uploaded by the user during the current second time period; (vii) a total videos tab associated with the user, the total videos tab, when selected, displaying for the user a second written description of the video files uploaded during the current second time period; (ix) a total votes for the user during the current second time period; (x) a bio section that displays a third written description of the user prepared by the user; and (xi) and any combination of (i) to (x).

19. A computer application capable of being loaded onto a web-based computer system, said computer application comprises software code that enables performance of the method of claim 1.

20. A computer system comprising:
a network interface; and
a processor in communication with the network interface, the processor being configured to perform the method of claim 1.
